(19) United States
(12) Patent Application Publication
(10) Pub. No.: US 2013/0134849 A1
(43) Pub. Date: May 30, 2013

(54) INSTRUMENT STORAGE CABINET SYSTEM

(71) Applicants: Peter F. Menzel, Owatonna, MN (US); Mark R. Friedrichs, Owatonna, MN (US); Kevin Krumholz, Owatonna, MN (US)

(72) Inventors: Peter F. Menzel, Owatonna, MN (US); Mark R. Friedrichs, Owatonna, MN (US); Kevin Krumholz, Owatonna, MN (US)

(21) Appl. No.: 13/305,275

(22) Filed: Nov. 28, 2011

(51) Int. Cl. A47B 81/00; B23P 17/04; A47B 47/00

(52) U.S. Cl. 312/265.5; 29/428

(57) ABSTRACT

A cabinet for being installed in an edifice adjacent a wall and above an underlying floor, includes a cabinet assembly the cabinet assembly being assemblable on site in the edifice from generally flat shipped disassembled cabinet assembly components, the components including at least a selected plurality of panels and shelves, and including a rail, the rail being formed of at least one rail member, the rail being fixedly couplable to the wall, the respective panels being shiftably suspendable form the rail during assembly and the panels being substantially supported by the underlying floor by selectively shiftably supports after assembly, the supports being shifted to a selected disposition in contact with the underlying floor. A method of assembling the cabinet is further included.

### FIELD OF THE INVENTION

The present invention relates generally to storage cabinets. More specifically, it relates to a configurable storage cabinet adapted for storing musical instruments.

### BACKGROUND

Musical instruments provide unique storage requirements. Instrument size poses a significant challenge for effective instrument storage. A complete band or orchestra includes small instruments such as flutes and clarinets, as well as large instruments such as sousaphones and tubas. Furthermore, instruments are generally fragile, so they are stored in large, rigid cases. Thus, instrument storage systems must include variably-sized storage compartments to accommodate all musical instruments in a given band or orchestra. Additionally, instruments for school are typically supplied by the parents of the students at considerable cost so the storage must be secure. School bands and orchestras often have limited storage space, so it is desirable to be able to configure instrument storage systems to minimize unused space.

Traditionally, musical instruments have been stored on standard shelving units, in which the shelves are configured to store different sized instruments. Standard shelving units have a number of disadvantages, including limited configurability and lack of security. Since musical instruments are generally valuable in nature, it is desired to provide a secured storage means, as noted above.

In response to these needs, storage cabinets have been designed specifically for the purpose of storing musical instruments. Recent musical storage cabinets exhibit improved configurability and durability. Despite such improvements, many cabinets are prohibitively expensive to ship assembled, the common means of providing such cabinets to a selected site.

What is needed is a configurable musical storage cabinet that incorporates novel design features that provide: (a) cost savings due to fewer components; (b) the ability to ship the cabinet as a flat assembly in order to minimize shipping costs; and (c) easy assembly and installation at the site.

### SUMMARY OF THE INVENTION

The present invention is intended to provide an instrument storage cabinet that provides improvements over existing cabinets in terms of ease of assembly, cost, and shipping expense. Assembly of the present invention is vastly improved by the multifunctional rail design, which (1) supports the weight of panels during on site assembly and allows panels to be easily adjusted laterally; (2) provides a single datum from which panels are hung, thereby reducing providing level alignment; (3) secures the cabinet to an existing wall, and (4) compensation for non-straight walls of the room in which the cabinet system is installed, thereby eliminating the need for additional anchoring hardware and back panel(s).

Cost is reduced because the present invention requires fewer components than prior cabinets, which is realized by (1) eliminating the rear cabinet panel by utilizing an existing wall as the back portion of the cabinet; and (2) eliminating double walls as used in modular cabinet systems by utilizing common internal walls; (3) spanning multiple columns with horizontal members; and (4) machining vertical panels to accept all shelf arrangements. Shipping size is further improved, as the present invention is shipped in its unassembled, flat state, which reduces freight by up to 60%.

Assembly at the site is made easier by pre-drilling all the bores necessary for supporting the shelves at selected positions and by assembling the door hinge support to mate with the shelves at the preselected shelf dispositions. By performing these assembly steps at the factory, assembly at the site is greatly simplified, involving only the simplest of hand tools and virtually no measuring, other than the initial leveling of a back support rail.

Finally, the cabinet system of the present invention is designed to provide security to individual storage compartments. Individual shelves are locked in place to prevent gaining access to a first storage leading to gaining unauthorized access to another storage compartment by removing an intervening shelf.

The cabinet of the present invention includes an interior portion that can include one or more individual storage compartments therein. Divider panels can be installed between the first and second end panel to provide the desired storage compartment width, and shelves can be installed therein to provide the desired storage compartment height. The open end of each storage portion can include a door, which can either comprise a solid material or grill bars.

A key feature of the present invention is a multifunctional back support rail. The rail is horizontally mountable on a wall, and includes a hook member and a retaining member. End panels and divider panels each include brackets that engage the hook member of the rail and allow the noted panels to be suspended therefrom during on site assembly. The rail hook member supports the panels vertically during assembly, while allowing a user to adjust the panel lateral position before the panels are supported by the underlying floor. The respective end panels are secured in place by adjusting cleats and the respective divider panels are supported by panel feet that are selectively brought into contact the floor and thereafter bear the weight of the cabinet system and its contents. The rail further provides a single leveling means for the entire cabinet assembly. Instead of leveling individual panels or storage modules, the rail provides a single datum from which all panels are hung, thereby reducing total leveling steps. The respective adjustable cleats and feet then compensate for an unlevel floor. The rail also provides the function of holding the top panels down and closing of gaps caused by variation in wall straightness.

During assembly, the first and second end panels are hung on the rail so that the hook portion of the rail provides vertical support, and the wall, to which the back edges of the panels abut, provides longitudinal support. It should be noted that the aforementioned wall is the wall of the room in which the cabinet system is being installed and becomes a component of the cabinet system during assembly of the cabinet system. The rail provides an initial datum to which the first and second end panels and one or more vertical divider panels are hung, thus providing a single means by which a series of cabinet columns are aligned. The rail further secures a cabinet bank to the wall of the structure in which the storage cabinet is being assembled. This allows an existing room wall to comprise the back portion of a cabinet bank, thereby eliminating the need for a rear cabinet panel, further providing cost savings and simplified installation.

The present invention further utilizes common interior divider panels, which can result in the elimination of one or more divider panels, depending on cabinet system size. Prior art instrument storage cabinets typically are modular in nature, so that two or more storage cabinet banks are placed next to each other if one storage bank does not provide adequate storage. Accordingly, a disadvantageous double wall exists between each cabinet bank. The present invention can be customized to virtually any length and height and is not constricted by storage bank size, as the respective panels may be readily placed at any desired disposition on the rail. As such, each interior vertical divider panel provides a shared wall for adjacent storage columns and double walls between banks are eliminated, resulting in further component elimination and associated cost savings. Accordingly, each bank of a multi-bank cabinet has at least one shared divider panel. The interior panels, both end and interior, are predrilled at the factory with shelf supporting bores. A support member is simply pressed into a respective bore in order to provide the shelf support. This further limits the amount of installation effort necessary at the installation site.

Vertical divider panels further include mounting feet so that the majority of the panel and instrument weight is supported by the floor as opposed to the back rail. The mounting feet are adjustable in order to ensure secure installation on wavy or uneven floors.

The present invention's simplified design allows it to be packaged substantially flat and shipped in its unassembled state. Thus, shipping costs are substantially less than prior instrument storage cabinets that had to be shipped in their fully-assembled state.

### BRIEF DESCRIPTION OF THE DRAWINGS

The invention may be more completely understood in consideration of the following detailed description of various embodiments of the invention in connection with the accompanying drawings, in which:

FIG. 1 is a perspective view of a cabinet assembly, according to an embodiment of the present invention;

FIG. 2 is a partial perspective view of a panel fixation assembly taken in the direction of arrow 2 in FIG. 1;

FIG. 3 is a partial sectional view of a panel fixation assembly taken along line 3-3 in FIG. 2;

FIG. 4 is a partial perspective view of a panel fixation assembly taken in the direction of arrow 4 in FIG. 1;

FIG. 5 depicts a trimetric view of a segment of a back rail, according to an embodiment of the present invention;

FIG. 6 is a sectional view of a back rail, taken along line 6-6 in FIG. 5;

FIG. 7 is a rear elevational view of a divider panel hanger, according to an embodiment of the present invention;

FIG. 8 is side elevational view of the divider panel hanger of FIG. 7;

FIG. 9 is an isometric view of the divider panel hanger of FIG. 7;

FIG. 10 is an isometric view of a left end corner bracket, according to an embodiment of the present invention;

FIG. 11 is a side elevational view of the left end corner bracket of FIG. 10;

FIG. 12 is front elevational view of the left end corner bracket of FIG. 10;

FIG. 13 is a plan view of the left end corner bracket of FIG. 10;

FIG. 14 is a partial view of a left end corner bracket, taken along line 14-14 in FIG. 11;

FIG. 15 is a trimetric view of a typical vertical divider panel, according to an embodiment of the present invention;

FIG. 16 is a trimetric view of a crosstree fastener bridge, according to an embodiment of the present invention;

FIG. 16A is a detail view of the vertical divider panel of FIG. 15, depicting a slot and step for engaging a crosstree fastener bridge, according to an embodiment of the present invention;

FIG. 17 depicts the crosstree fastener bridge of FIG. 16 coupled to a portion of a vertical divider panel as depicted in FIG. 16A;

FIG. 18 is a detail view of the vertical divider panel of FIG. 6, depicting an adjustable foot, according to an embodiment of the present invention;

FIG. 19 is a trimetric view of a crosstree fastener bridge depicting the bottom side thereof, according to an embodiment of the present invention;

FIG. 20 is a trimetric view of a crosstree fastener bridge depicting the top side thereof, according to an embodiment of the present invention;

FIG. 21 is a front elevational view of a crosstree fastener bridge, including hidden lines to depict internal features, according to an embodiment of the present invention;

FIG. 22 is a sectional view of a crosstree fastener bridge, taken along line 22-22 of FIG. 21;

FIG. 23 is an exploded view of a vertical divider panel and front door extrusion assembly, according to an embodiment of the present invention;

FIG. 24 is a partial side elevational view of the vertical divider panel and front door extrusion assembly of FIG. 23 prior to final engagement of the same and including hidden lines depicting internal features, as viewed from the direction of arrow 24 of FIG. 23;

FIG. 25 is a sectional view of the vertical divider panel and front door extrusion assembly of FIG. 24, taken along line 25-25 of FIG. 24;

FIG. 26 is a partial side elevational view of the vertical divider panel and front door extrusion assembly of FIG. 23 after final engagement of the same and including hidden lines depicting internal features, as viewed from the direction of arrow 24 of FIG. 23;

FIG. 27 is a sectional view of the vertical divider panel and front door extrusion assembly of FIG. 26, taken along line 27-27 of FIG. 26;

FIG. 28 is an isometric view of the top bracket, according to an embodiment of the present invention;

FIG. 29 is an isometric view of the bottom bracket, according to an embodiment of the present invention;

FIG. 30 is an isometric view of a single shelf pin, according to an embodiment of the present invention;

FIG. 31 is an isometric view of a double shelf pin, according to an embodiment of the present invention;

FIG. 32 is an isometric view of a threaded end panel shelf pin, according to an embodiment of the present invention;

FIG. 33 is a perspective view of a door extrusion with a plurality of doors shiftably coupled thereto;

FIG. 34 is an enlarged perspective view of the uppermost door of FIG. 33;

FIG. 35 is a perspective view of the cabinet assembly, as disassembled and packed flat on a pallet, according to an embodiment of the present invention;

FIG. 36a includes an elevational depiction of a threaded support pin and an elevational depiction of the support pin engaged with a shelf;

FIG. 36b includes an elevational depiction of a single support pin;

FIG. 36c includes an elevational depiction of a single support pin, the support pin engaged with opposing shelves; and

FIG. 37 is an elevational view of the installation steps AA, BB, and CC of a shelf.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION OF THE DRAWINGS

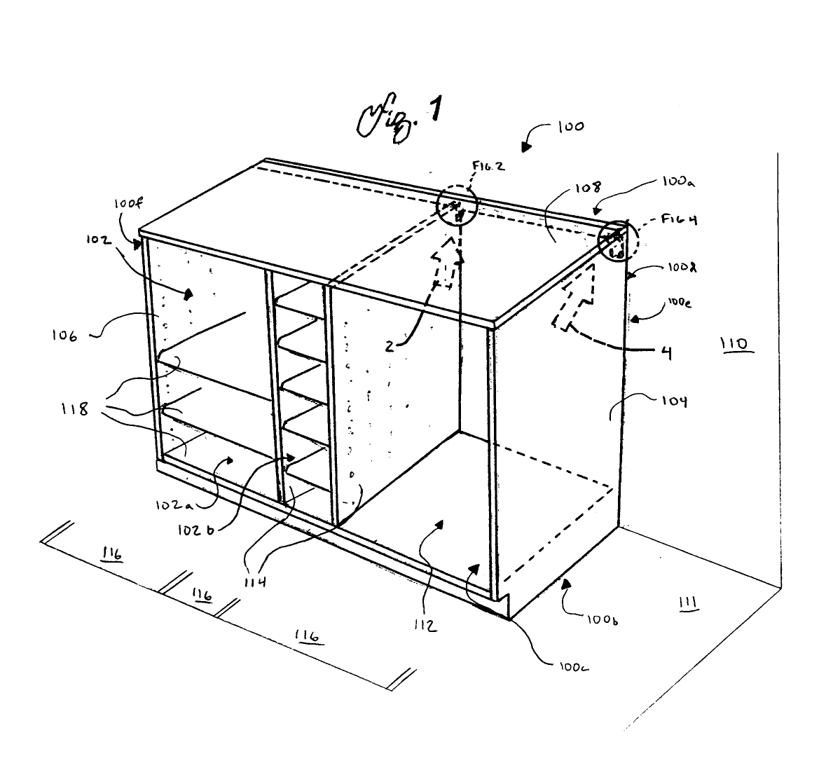

Referring to FIG. 1, instrument storage cabinet system 100 according to an embodiment of the present invention can include one or more storage compartments 102. Cabinet system 100 broadly includes first and second respective opposing end panels 104, 106, top panel 108, and utilizes wall 110 to which instrument storage cabinet system 100 is installed in lieu of a discrete back panel, all of which define an open interior 112. Wall 110 is the wall of the room as noted above. One or more divider panels 114 can be installed to divide interior 112 into a plurality of columns 116. A column or bank 116 can itself be utilized as a storage compartment 102 or one or more shelves 500 can be installed to divide column 116 into a plurality of smaller storage compartments 102. Each individual storage compartment 102 can be enclosed by a locking door assembly 402 (described in greater detail below), which can comprise a substantially open, grill-like configuration, or a substantially closed, solid configuration. An open shelf or no door configuration is also possible. Suitable doors for use in an instrument storage cabinet according to the present disclosure are disclosed in U.S. Pat. Nos. 4,826,265 and 7,921,960 (both of which are assigned to Wenger Corporation, the Assignee of the present application), which are hereby incorporated by reference. Divider panels 114 and shelves 500 can be configured to provide storage compartments 102 sized to accommodate virtually any instrument storage requirement. Divider panels 114 and shelves 500 can also be added, removed, or otherwise reconfigured after initial installation, depending on storage needs at any given time. Divider panels 114 further comprise a shared wall for adjacent storage columns 116, resulting in further component elimination and associated cost savings as compared to modular storage cabinets that comprise double walls between cabinet banks.

First and second opposing end panels 104, 106, top panel 108, and divider panel(s) 114 are preferably about ¾″ thick and may consist of industrial-grade composite wood, environmentally sensitive (no added urea formaldehyde) wood, moisture-resistant wood, or Vencore (plywood); however, such panels 104, 106, 108 and 114 may consist of any suitable wood, composite, or plastic material, of any suitable thickness. Such panels may also include a polyester laminate finish or other suitable paint or finish, as desired. As further cost savings, it is desirable to utilize different laminate colors on external surfaces such as first end panel 104e and second end panel 106e outer surfaces, and top panel 108a top surface, which eliminates the need for end covers that have typically been required for prior cabinet systems.

FIGS. 2, 3, 5, and 6 depict rail system assembly 150. Relevant to the present figures, top panel 108 has top face 108a, bottom face 108b, and back face 108d; divider panel 114 has top face 114a and back face 114d; and wall 110 has exposed face 110a. Rail 152 is mounted horizontally to exposed face 110a of wall 110 by fasteners 154. Preferably, rail 152 is mounted so that fasteners 154 each engage with a stud in wall or concrete masonry unit (CMU) 110 but may as well be coupled to wall 110 by means of common dry wall fasteners. Rail 152 may be comprised of extruded aluminum; however, any other suitable material may be used, including but not limited to metals or metal alloys, which may be extruded, stamped, cut, or otherwise formed, or any suitable injected molded plastic or other polymer-based material.

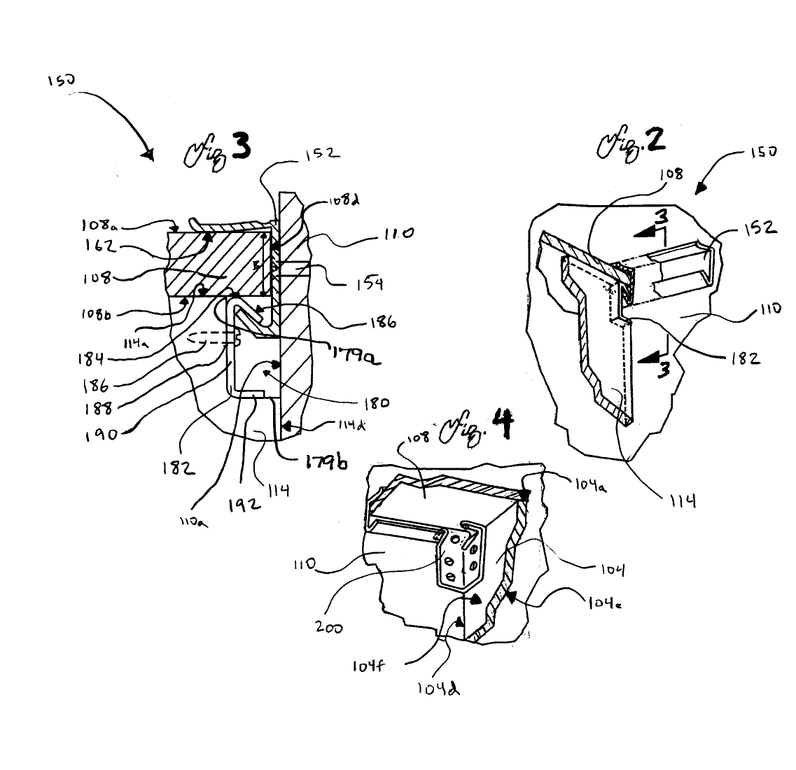

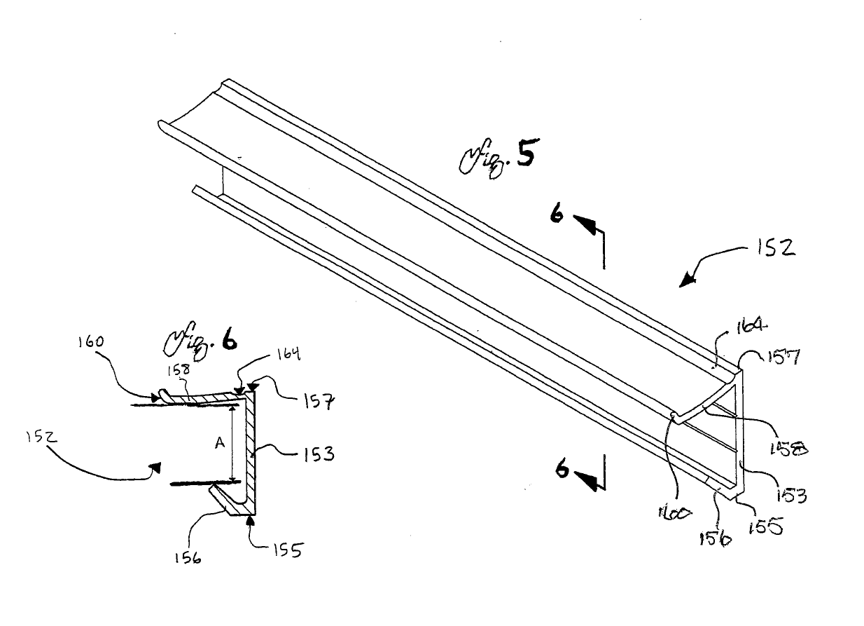

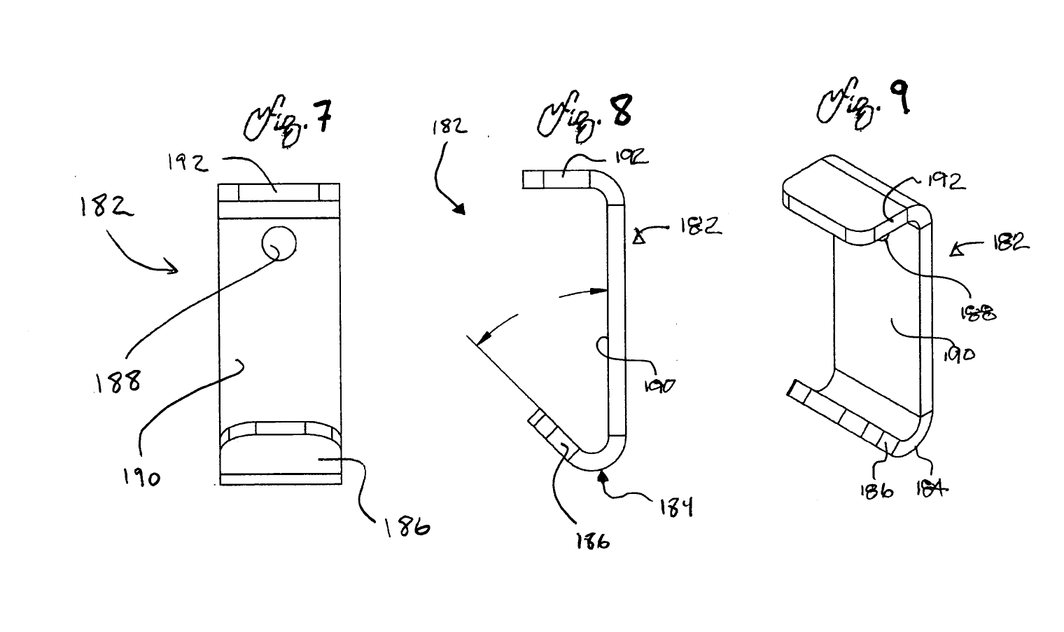

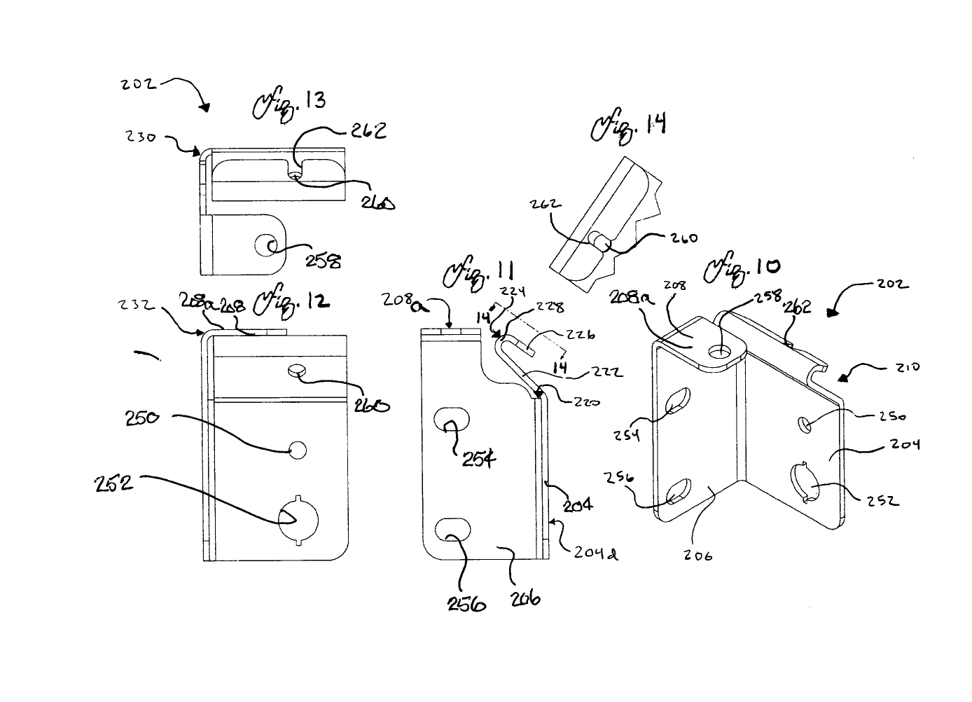

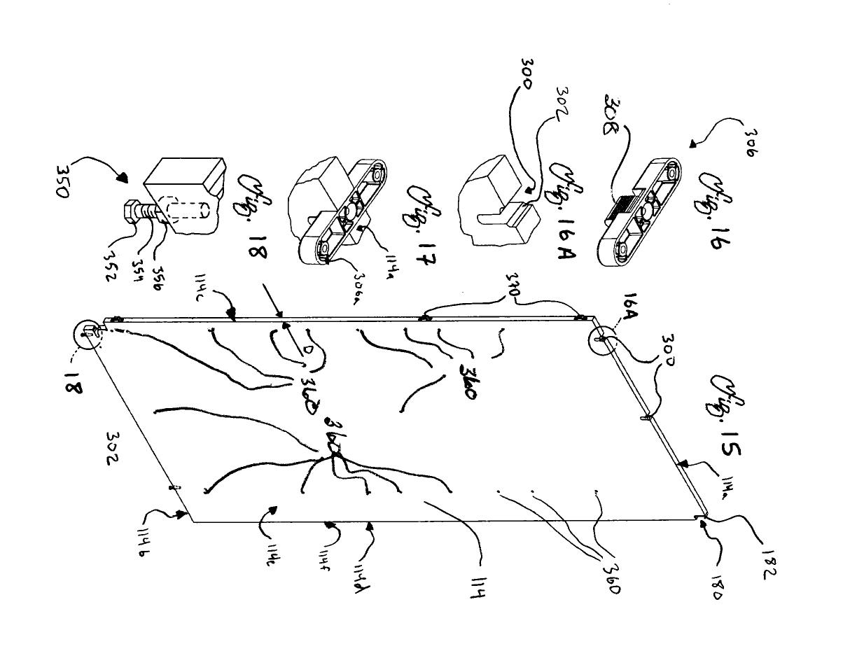

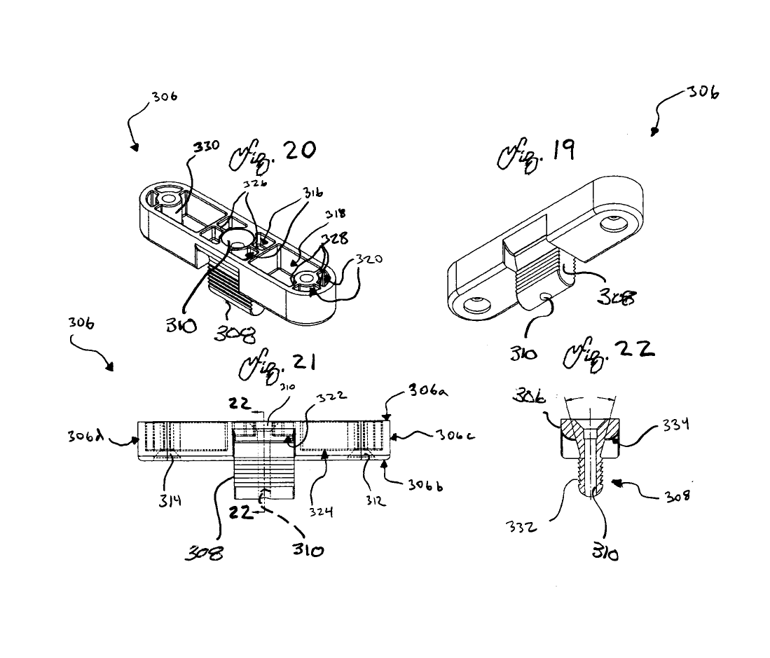

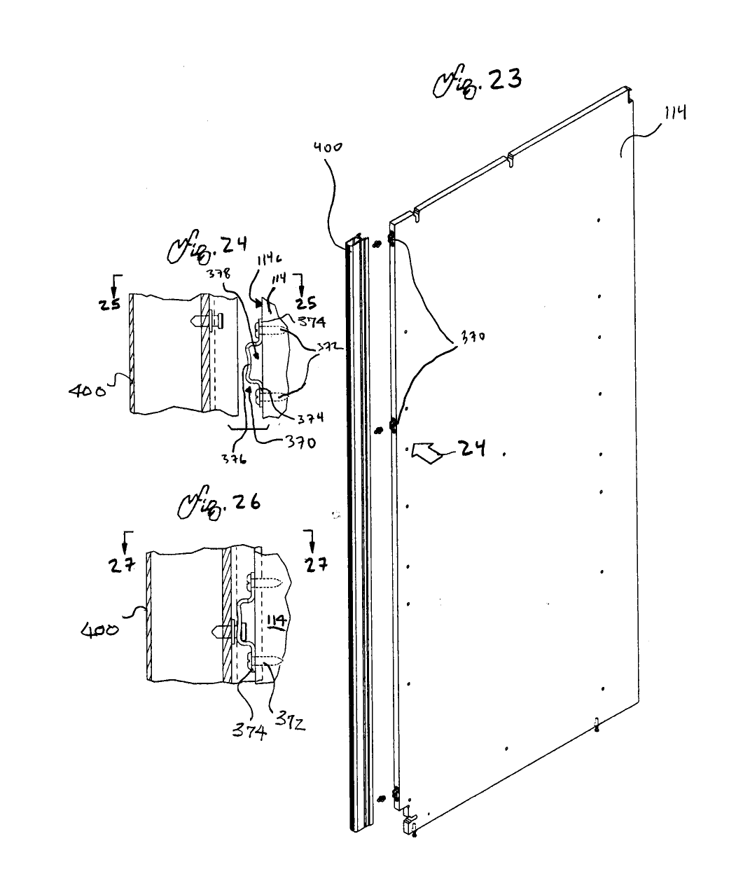

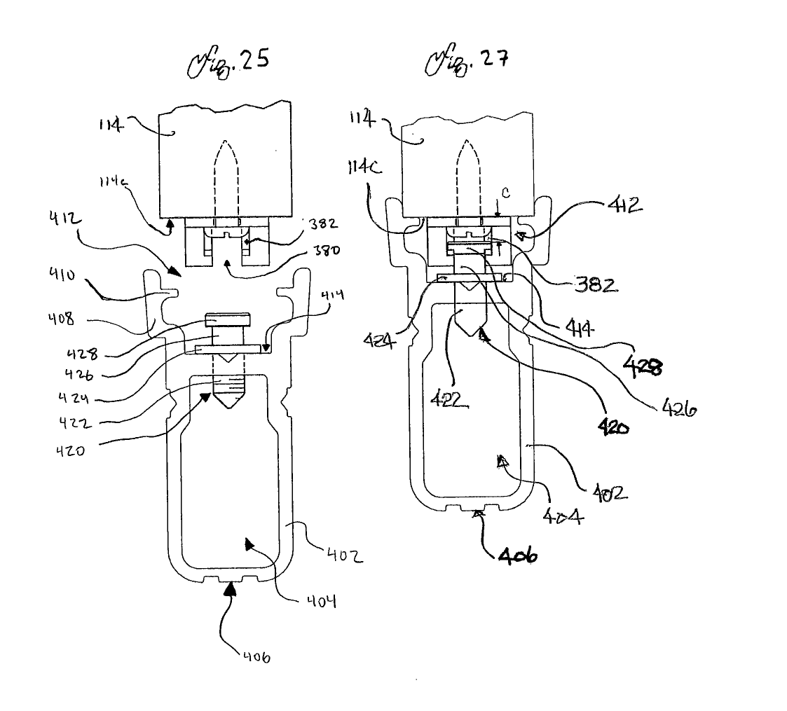

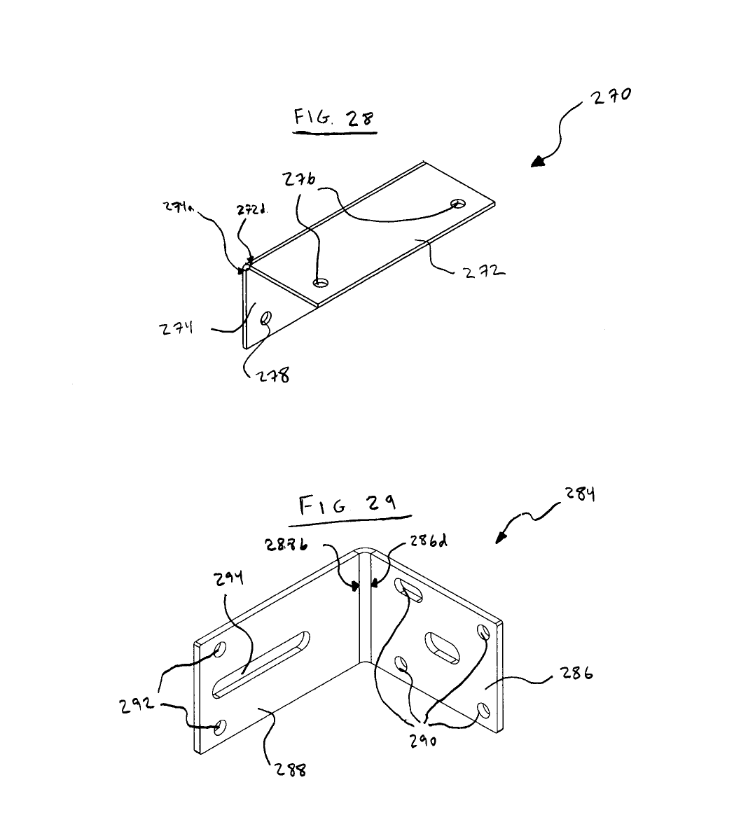

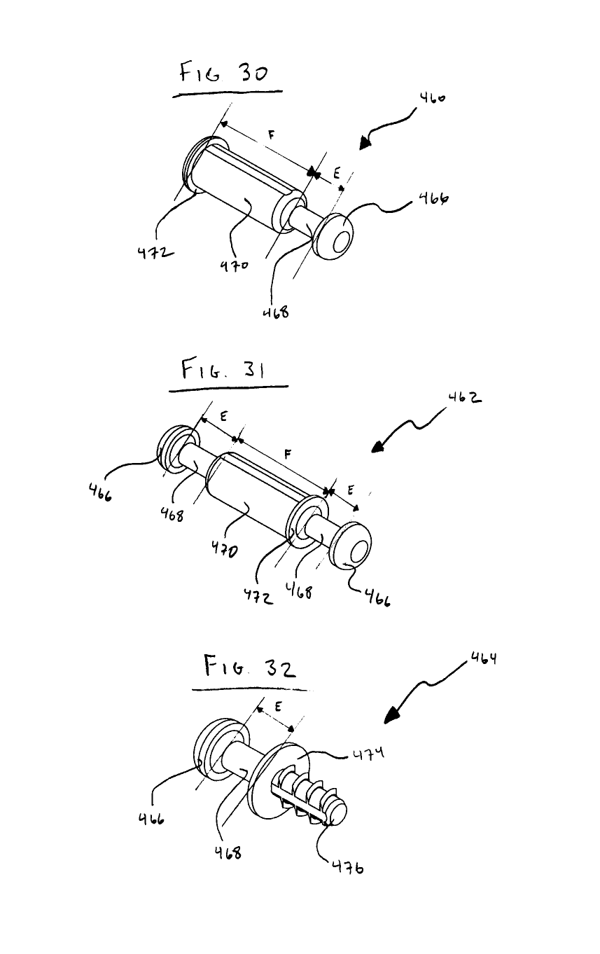

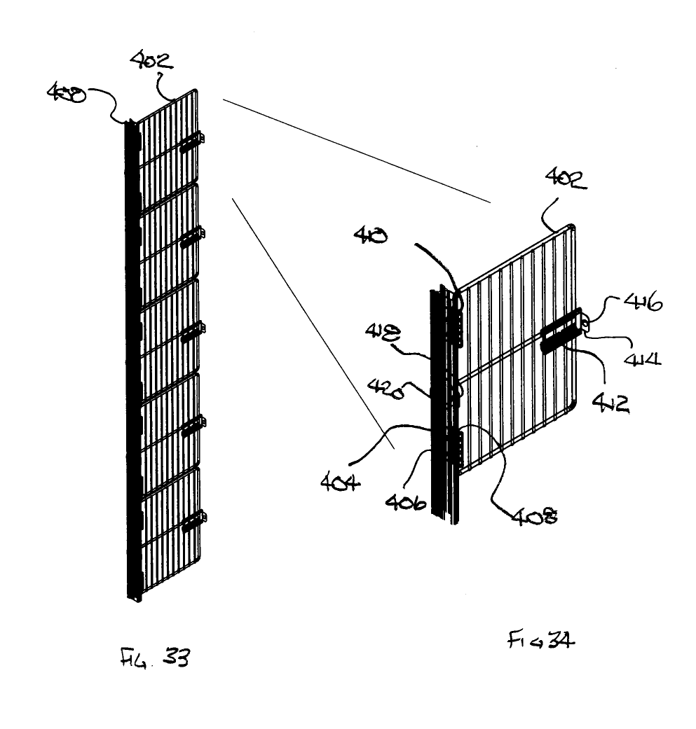

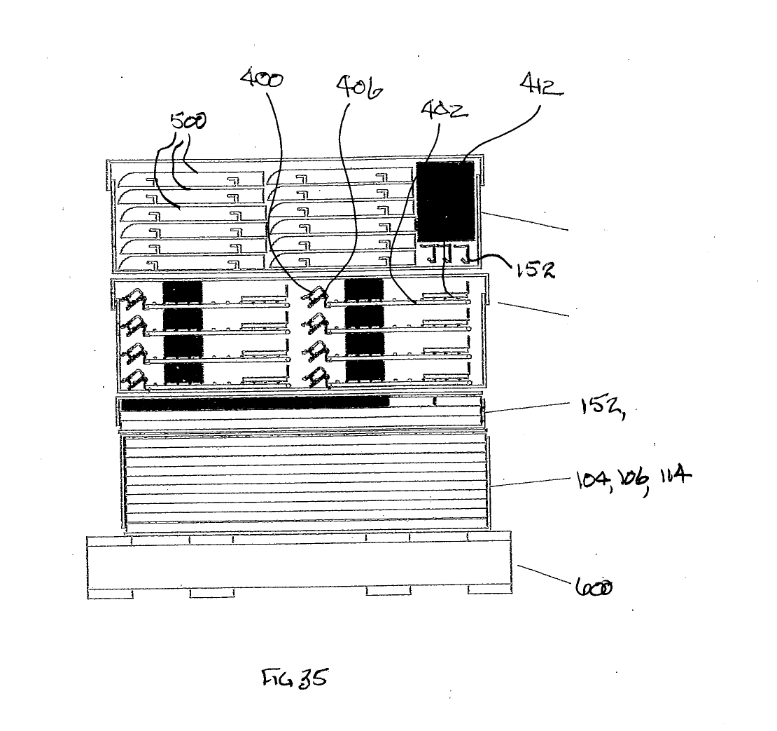

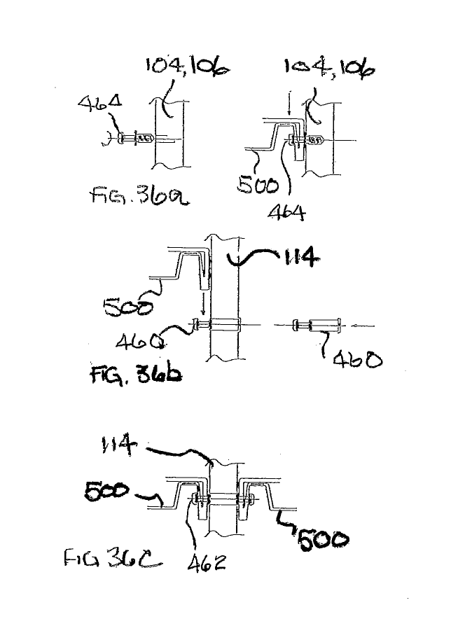

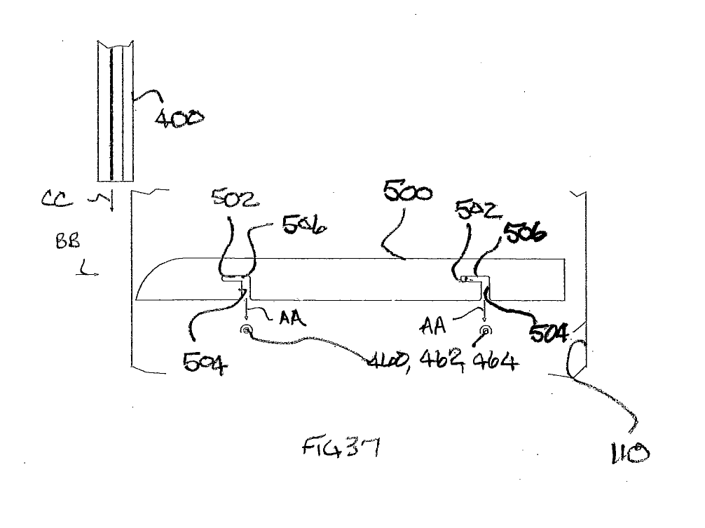

Referring now to FIG. 6, rail 152 has backing plate 153 with bottom edge 155 and retaining member 158 formed integrally therewith. Hook member 156 extends outwardly and upwardly from bottom edge 155, and retaining member 158 extends outwardly and slightly downwardly from top edge 157. Retaining member 158 defines an included angle with backing plate 153 of something less than 90°. Retaining member 158 includes rounded leading edge 160 and narrowed portion 164. As explained in further detail below, top panel 108 is compressively held between the top edge of divider panel(s) 114 and bottom edge 162 of retaining member 158 as depicted in FIGS. 2-4. In its unassembled state, retaining member 158 extends slightly downwardly so that gap A (see FIG. 6) between bottom edge 162 of retaining member 158 and top edge 114 of divider panel 114 is slightly smaller than thickness B (see FIG. 3) of top panel 108. Narrowing portion 164 reduces the stiffness of retaining member 158, allowing resilient retaining member 158 to flex sufficiently to accept top panel 108 and thence to exert a compressive force on top panel 108. While top panel 108 is being installed to its final position as depicted in FIGS. 2 and 3, rounded leading edge 160 facilitates engagement with retaining member 158. As installed, back face 108d of top panel 108 abuts the vertical face of rail 152, bottom face 108b abuts top face 114a of divider panel(s) 114, and bottom edge 162 of retaining member 158 provides a compressive force against top face 108a, thereby retaining top panel 108 in its desired disposition.

Referring to FIG. 3, divider panel 114 includes generally rectangular cutout 180 located in the corner adjacent top face 108a and back face 108d. Cutout 180 is defined by orthogonally disposed cuts 179a and 179b. Bracket 182 is fixably attached to divider panel 114 within cutout 180 by fastener 186. Fastener 186 is passed through a bore 188 defined in back plate 190. Back plate 190 is disposed flush with cut 179a. Bracket 182 has top edge 184 formed at the top of back plate 190 from which hook member 186 extends outwardly and downwardly. Bottom leg 192 conforms to cut 179b of cutout 180 and supports bracket 182. Bracket 182 and cutout portion 180 are further shaped so that hook member 186 of bracket 182 engages with hook member 156 of rail 152; when engaged, back face 114d of divider panel 114 abuts flush to exposed face 110a of wall 110. Engaging bracket 182 to rail 152 slidably couples divider panel(s) 114 to rail 152, thereby allowing a user to easily hang panel(s) 114 on rail 152 and to laterally adjust panel(s) 114 prior to installing shelves 500.

Referring now to FIG. 4, right corner bracket 200 fixably couples first end panel 104, top panel 108, wall 110, and rail 152 by means of three orthogonally disposed faces noted below. Relevant to the present figure, first end panel 104 has top face 104a, back face 104d, outer face 104e, and inner face 104f. It should be noted that right corner bracket 200 and left corner bracket 202 are substantially equivalent, except that they are mirror images of one another, as depicted in FIGS. 10-14 and FIG. 4. For purposes of illustrating key corner bracket 200 and 202 features, left corner bracket 202 is utilized in FIGS. 10-14. Corner brackets 200, 202 provide rigidity to cabinet system 100 by tying end panels 104, 106 to wall 110.

Left corner bracket 202 comprises back member 204, side member 206, top member 208, generally formed at right angles to one another, and hook portion 210. Back member 204 has top edge 220 from which first hook member 222 extends inwardly and upwardly to top edge 224. Second hook member 226 extends outwardly and downwardly from top edge 224 of first hook member 222, with radius 228 formed at top edge 224 adjacent first hook member 222 and second hook member 226. First and second hook members 222, 226, including radius 228, comprise hook portion 210, which is substantially similar in shape to hook member 186 of bracket 182, so as to facilitate engagement with hook member 156 of rail 152. Back member 204 has outer edge 230, from which side member 206 extends outwardly and substantially orthogonally. Side member 206 has top edge 232 from which top member 208 extends inwardly and substantially horizontally.

Bracket 202 includes a plurality bores (described in detail below) defined in respective faces to accept fasteners, which fasteners fixably couple first end panel 104 top panel 108, wall 110, and rail 152. Back member 204 includes first and second bores 250, 252; side member 206 includes first and second bores 254, 256; top member 208 includes bore 258; and first hook member 222 includes bore 260. Such bores can be circular, slotted, or any shape sufficient to accept a fastener. Second hook member 226 further includes cutout 262, the center of which is substantially aligned with bore 260 so as to avoid interference with a fastener that may be inserted therein.

FIGS. 15-18 depict a respective divider panel 114. Divider panel 114 has top face 114a, from which one or more slot(s) 300 extend downwardly; bottom face 114b, from which one or more adjustable feet 350 extend downwardly; front face 114c, to which clips 370 are attached; and respective first and second faces 114e, 114f, into which a plurality of shelf mounting bores 360 are defined. It should be noted that the ultimate configuration of the storage cabinet system 100 is known at the factory and accordingly, the bores 360 are preferably defined at the factory.

As shown in FIGS. 16, 16A, and 17, slot 300 is shaped to frictionally engage a crosstree barbed connector 306 by means of a pressed engagement. When crosstree barbed connector 306 (see particularly FIG. 20) is fully pressed into slot 300, top face 306a of crosstree barbed connector 306 is flush with top face 114a of divider panel 114, as depicted in FIG. 17. Crosstree barbed connector 306 is depicted in further detail in FIGS. 19-22. Barbed connector 306 is generally shaped as a bar, generally rectangular in cross section, with rounded first 306c and second 306d ends, and with retention feature 308 extending downwardly from bottom edge 306b, the barbed member 308 being substantially centered between first end 306c and second end 306d. Depending barbed member 308 includes upward directed teeth 332 that engage slot 300 to secure barbed connector 306 therein. Slot 300 includes rounded stop 302 which provides a positive stop for rounded edge 334 of barbed connector 306, which limits the installation depth of barbed connector 306. Barbed connector 306 allows dividers to be rigidly connected to top and kicker panels without the need for machining.

Barbed connector 306 includes cavities 316, 318, and 320, which each extend downwardly from top face 306a, partially through barbed connector 306. Cavities 316 define gussets 326, which act to rigidize center fastener bore 310. Cavities 318 and 320 define bosses 330 and gussets 328, wherein bosses 330, respectively, comprise side fastener bores 312 and 314. Center fastener bore 310 extends from top face 306a through retention feature 308, and is chamfered. In most geographic areas, fastener bore 310 is not used, but, in areas subject to seismic events, a screw may be passed through bore 310 and tapped into panel 114. Side fastener bores 312 and 314 extend from bottom face 306b through top face 306a and are also chamfered.

Referring to FIGS. 15 and 18, one or more adjustable feet 350 extend downwardly from bottom face 114a of each divider panel 114. Adjustable feet 350 comprise head 352, threaded shaft 354, and locking nut 356. Foot 350 is threadedly coupled orthogonally into bottom face 114a of divider panel 114. Locking nut 356 is threadedly coupled to shaft 354 and is disposed between head 352 and bottom face 114a. A user can adjust the effective length of feet 350 by screwing feet 350 into or out of panel 114, and tightening locking nut 356 against bottom panel face 114a to fix a position of a respective foot 350.

FIGS. 23-27 depict divider panel 114, clips 370, and door extrusion 400. Clip 370 comprises feet 374 and clip member 376. Clip member 376 is offset from feet 374 so as to define void 378, and is bowed slightly concavely towards front panel face 114c. Clip member 376 further includes slot 380 and vertical stop 382 (see FIG. 25). Each divider panel 114 includes two or more clips 370, which are attached to front face 114c by fasteners 372 attached through feet 374.

Door extrusion 400 comprises extruded body 402, interior bore 404, exposed surface 406, legs 408, standoffs 410, and engagement portion 412. Fastener 420 is threadably attached to face 414 of body 402 disposed within engagement portion 412. Fastener 420 comprises shaft 422, shoulder 424, and head 428. Shaft portion 426 between head 428 and shoulder 424 is unthreaded and the portion extending outwardly from shoulder 424 is threaded.

FIGS. 23, 24 and 25 depict door extrusion 400 in a spaced apart disposition prior to engagement with panel 114. FIGS. 26 and 27 depict door extrusion 400 in an engaged disposition with panel 114. In such disposition, door extrusion 400 overlaps a portion of the leading edge of the shelves and, accordingly, locks shelves 500 in place, as described below, thus providing security between vertically adjacent storage compartments 102.

FIG. 27 depicts door extrusion 400 engaged with clip 370. In this position, fastener 420 is disposed within slot 380 of clip member 376 so that head 428 of fastener 420 abuts stop 382. Standoffs 410 of door extrusion 400 abut front surface 114c of divider panel 114, which maintains head 428 at a pre-defined distance C from face 114c. Fastener 420 enters slot 380 from above and is driven downward, preferably with soft mallet blows into the engaged disposition. In this position, head 428 engages the bowed portion of clip member 376 and forces it slightly outward, providing a spring force against head 428 which aids in the retention of door extrusion 400 to clip 370.

Door extrusion 400 preferably consists of extruded aluminum; however, it may consist of any suitable material that is high-strength and relatively low in cost, including but not limited to other metals or alloys thereof, or molded plastics. Door extrusion 400 may further be painted or powder-coated various colors to match doors and/or door hardware, if desired. If doors are to be installed, door hinges 406 are mounted directly to door extrusion 400, which provides high strength metal-to-metal hinge attachment. See in particular FIGS. 33 and 34.

Door extrusion 400, fasteners and clips 370 allow doors 402 and strike plates to be prehung at the factory with minimal labor to attach to vertical panels in the field. Door extrusion 400 provides a durable edge and a secure tamper resistant connection for each compartment 102. A first portion 404 of hinge 406 is formed integral with door extrusion 400. A second portion 408 of hinge 406 is formed integral with the door 402. The portions 404, 408 are shiftably coupled together with a hinge pin 410. Each door 402 includes a handle (or lock housing) 412. The handle 412 includes a locking tab 414 with a bore 416 defined therein. When the door 402 is in the closed disposition, tab 414 is disposed adjacent a locking tab 418 formed integral with door extrusion 400 that is disposed on an adjacent panel 114 (not depicted). Tab 418 has a bore 420 formed therein that is brought into registry with bore 416 and a padlock may be passed through the bores 416, 420 to lock the door 402.

FIG. 28 depicts top bracket 270, which fixably couples end panels 104, 106, respectively, to top panel 108. Bracket 270 includes a top member 272. Top member 272 has back edge 272d and side member 274 has top edge 274a, wherein edges 272d and 274a are contiguous and members 272 and 274 are orthogonal by disposed, forming top bracket 270 in an L-shaped cross section. Top member 272 has a plurality of fastening bores 276, through which preferably threaded fasteners are disposed to fixably couple top bracket 270 to top panel 108, and side member 274 includes a plurality of fastening bores 278, through which fasteners are disposed to fixably couple top bracket 270 to respective end panel 104 or 106.

FIG. 29 depicts cleat 284, which fixably couples first end panel 104 and second end panel 106, respectively, to floor 111. Bottom member 286 has back edge 286d and side member 288 has bottom edge 288b, wherein edges 286d and 288b are contiguous and members 286 and 288 are orthogonal, forming L-shaped cleat 284. Bottom member 286 has a plurality of fastening bores 290, through which preferably threaded fasteners are disposed to fixably couple cleat 284 to floor, and side member 288 includes a plurality of fastening bores 292 and slot 294, through which a plurality of fasteners are disposed to fixably couple cleat 284 at a selected height relative to end panel 104 or 106 such that bottom member 286 is in engagement with the underlying floor 111.

Referring now to FIGS. 30-32 and 36a-36c, various shelf pins are depicted; FIG. 30 depicts single internal shelf pin 460, FIG. 31 depicts double internal shelf pin 462, and FIG. 32 depicts end panel shelf pin 464. A plurality of shelf pins 460 and 460 are slidably coupled to divider panel(s) 114 through shelf mounting bores 360, to engage with and support a plurality of shelves 500. A suitable shelf for use in an instrument storage cabinet according to the present disclosure is disclosed in U.S. Pat. No. 4,826,265 (assigned to Wenger Corporation), which is hereby incorporated by reference. Pin 462 is utilized if shelves 500 adjacent both faces 114e and 114f of divider panel 114 are mounted at the same height; otherwise, pin 460 is utilized. Pins 460 and 462 each comprise cylindrical body portion 470, which has length F that is substantially equivalent to divider panel thickness D. One end of pin body 470 has flange 472, which abuts divider panel 114 face 114e or 114f, and controls insertion depth. Pin shank 468 extends outwardly and coaxially from pin body 470, opposite the end comprising shank 468, the end of which comprises head 466. Pins 460, 462, and 464 each comprise substantially equivalent shank 468 and head 466. Shank 468 has length E, which protrudes from divider panel 114 face 114e or 114f. Double pin 462 further comprises a second, substantially equivalent shank 468 and head 466, extending outwardly from flange 472. Shank 468 and head 466 are shaped so as to engage with complimentary features in shelves 500 so that pins 460, 462, and 464 securely support shelves 500. End panel shelf pin 464 also comprises head 466 and shank 468. Flange 474 extends outwardly and coaxially from shank 468, opposite head 466. Extending outwardly and coaxially therefrom is threaded shaft 476, which threadably couples end panel shelf pins 464 to end panels 104 and 106, respectively.

Shelf pin supports 462 and 464 are designed to be installed without tools by pressing into bores 360 of panel(s) 114 and bores 361 of respective panels 104 (See FIGS. 1 and 15 and 36b and c). Shelf pin supports 460, as depicted in FIG. 36a is designed to be threaded into predrilled bore 361 of a respective end panel 104, 106. The bore 361 formed in the end panels 106 is slightly lesser in diameter than the threads of support 460 to allow the support 460 to threadedly engage the panel 106. Referring to FIG. 35, slots 502, defined in the shelf 500 allow the shelf 500 to be dropped over pins 460, 462, or 464 and slid backwards to fully engage the shelf 500 to prevent tampering. The slot 502 has a substantially vertical portion 504 coupled in an L shape to horizontal portion 506. To effect the coupling of the shelf to respective pin supports 460, 462, 464, the shelf 500 is dropped over the respective pin supports 460, 462, 464 and into portion 504. This brings the respective pin supports 460, 462, 464 to the L angle of the slot 502. Sliding the shelf rearwards to the wall 100, captures the shelf 500 on the respective pin supports 460, 462, 464. Sliding the door extrusion 400 downward, as indicated causes the door extrusion 400 to overlap a portion of the leading edge 510 of the shelf 500. Installation of door extrusion 400, as noted above, prevents shelves 500 from moving forward after installation, thereby locking the shelves 500 in place. These means of installation are depicted in FIGS. 36a-36c and 37. Installation of top panel 152 causes a portion of panel 152 to overly the top end of door extrusion 400, thereby securing the door extrusion 400 in place.

A more detailed method for assembling instrument storage cabinet system 100 will now be discussed. A user receives unassembled storage cabinet system 100 as depicted in FIG. 38 packed flat on a pallet 450. After unpacking all of the component parts, the first step is to secure rail 152 to wall 110. The height at which rail 152 is installed is determined by the total height of the particular storage cabinet system 100. Rail 152 is placed horizontally on wall 110 in the desired location and leveled, such that hook member 156 is nearest the floor and retaining member 158 is nearest the ceiling, and rail 152 is secured to wall 110 by two or more fasteners 154. Preferably, fasteners 154 engage studs in wall 110 but may as well be coupled to wall 110 by means of common dry wall fasteners, or concrete masonry.

Before securing the fasteners 154, it is important for a user to ensure that rail 152 is horizontally level. Because end panels 104 and 106, and divider panels 114 are hung from rail 152 during installation, rail 152 provides a single datum by which the entire cabinet system 100 is horizontally leveled. As such, fewer total leveling steps are required; however, it is important to ensure that this single horizontal leveling step is done properly.

Corner brackets 200 and 202 (see FIGS. 10-14) are next attached to first 104 end panel and second end panel 106, respectively. End panels 104, 106 have an outer side 104e that is finished to a certain exterior color or pattern, and an inner face 104f that is finished to a certain interior color or pattern. Corner brackets 200 and 202 are attached to end panels 104 and 106 by aligning the back face 204d (see FIG. 11) of back bracket member 204 with back panel face 104d and top face 208a of top bracket member 208 with top end panel face 104a, and securing side bracket member 206 to inner panel face 104f with fasteners through bores 250 and 252.

A plurality of cleats 284 are then placed so that side member 288 abuts inner end panel faces 104f or 106f, respectively, and bottom member 286 extends outwardly from inner end panel faces 104f or 106f, respectively, and is substantially coplanar to bottom end panel faces 104b or 106b, respectively. Cleats 284 are then fixably yet adjustably coupled to end panels 104 and 106 by fastening cleats 284 through elongate slot 294.

After cleats 284 are installed, a plurality of top brackets 270 are then placed so that side member 274 abuts inner end panel face 104f or 106f, and top member 272 extends outwardly from inner end panel face 104f or 106f, and is substantially coplanar to top end panel face 104a or 106a. Top brackets 270 are then fixably yet adjustably coupled to end panels 104 and 106 by fastening brackets 270 through side member fastening bores 278.

First and second end panels 104, 106 are then hung on rail 152 so that inner faces 104f are facing one another. End panels 104 and 106 are then leveled vertically and fastened to rail 152 and wall 110, and cleats 284 are fastened to floor 111.

Divider panel(s) 114 are then hung to rail 152 by engaging bracket hook member 186 with rail hook member 156. After all divider panels 114 are hung, feet 350 are adjusted so that foot head 352 meets floor 111. Once adjusted, locking nut 356 is tightened against bottom panel face 114b.

It now becomes evident that hook member 156 of rail 152 provides vertical support for divider panels 114 when the panels are initially placed and adjusted; however, the majority of vertical support is shifted to feet 350 after the panels are adjusted. Once feet 350 have been adjusted, hook member 156 of rail 152 primarily prevents cabinet system 100 from tipping forward, away from wall 110.

Shelves 500 are next installed, as depicted in FIGS. 36a-36c. Single 460 and/or double 462 shelf pins are inserted into divider panel(s) 114 through shelf mounting bores 360 at desired shelf heights. End panel shelf pins 464 are threadably attached to end panels 104 and 106, respectively, through shelf mounting bores 360 at desired heights. Shelves 500 are mounted onto pins 460, 462, and/or 464 as indicated by arrow AA. The shelf 500 is then translated rearward, as indicated by arrow BB, moving the respective pin 460, 462, 464 into horizontal portion 506 of slot 502. Door extrusion is then lowered into place, as indicated by arrow CC, thereby locking shelf 500 in place.

Crosstree fastener bridges 306 are then pressed into slots 300 of divider panel(s) 114 so that top bridge face 306a is flush with top panel surface 114a; barbed connector 306 is fastened to divider panel through center fastener bore 310. Door extrusion 400 is then attached to front panel surface 114c by positioning door extrusion 400 so that standoffs 410 touch front panel surface 114c and so that fasteners 420 are disposed above clips 370. Door extrusion 400 is then lowered so that fastener head 428 is disposed within slot 380 and touches stop 382 of clip 370. Bowed member 376 of clip 370 is pressed slightly outward by head 428 at this point, thereby providing a spring force that retains door extrusion 400 to divider panel 114.

Top panel 108 is then installed so that back surface 108d abuts rail 152 and the panel is sandwiched between top surface 114a of divider panel(s) 114 and retaining member 158 of rail 152. Once positioned, top panel 108 is then affixed by fasteners through bores 312 and 314 of each crosstree barbed connector 306, and by fasteners through bores 276 of top bracket 270. A kick panel 530 is affixed at the very bottom of the cabinet system 100, generally flush with the underlying floor.

Storage cabinet system 100 is now fully assembled.

1. A cabinet for being installed in an edifice adjacent a wall and above an underlying floor, comprising:
a cabinet assembly, the cabinet assembly being assemblable on site in the edifice from generally flat shipped disassembled cabinet assembly components, the components including at least a selected plurality of panels and shelves, and including a rail, the rail being formed of at least one rail member, the rail being fixedly couplable to the wall, the respective panels being shiftably suspendable from the rail during assembly and the panels being substantially supported by the underlying floor by selectively shiftably supports after assembly, the supports being shifted to a selected disposition in contact with the underlying floor.

2. The cabinet of claim 1, comprising a bracket fixedly couplable to a respective panel, the bracket being adapted for engaging the rail in a depending disposition.

3. The cabinet of claim 2, the bracket having a hook member, the hook member for engaging a mating hook member of the rail.

4. The cabinet of claim 3, wherein a top panel is removably, compressively captured by the bracket, the top panel thereby acting to maintain the respective panels in suspended engagement with the rail.

5. The cabinet of claim 1, the rail providing a single datum from which all of the plurality of panels are suspended thereby minimizing the number of steps necessary to level the cabinet assembly.

6. The cabinet of claim 1, wherein the cabinet assembly employs the wall as a back portion of the cabinet assembly, thereby eliminating the need for a dedicated cabinet back panel.

7. The cabinet of claim 1, including a corner bracket, the corner bracket having a hook and three orthogonally disposed members, the hook member for engaging a mating hook member of the rail, and the respective orthogonally disposed members for coupling to a respective panel, a top panel, and the wall.

8. The cabinet of claim 1, including suspending a first end panel and a second end panel from the rail in a selected spaced apart disposition, the end panels including adjustable cleats for affixing the first end panel and the second end panel to the underlying floor.

9. The cabinet of claim 8, including suspending a selected number of panels from the rail in selected spaced apart dispositions between the first end panel and the second end panel and each of the selected number of panels including a plurality of adjustable feet for at least in part supporting the selected number of panels on the underlying floor.

10. The cabinet of claim 1, including a single panel being provided between adjacent columns of the cabinet assembly, each of the single panels being adapted for supporting shelves on opposing sides of the respective single panels.

11. A cabinet for being installed in an edifice adjacent a wall and above an underlying floor, comprising:
a cabinet assembly, the cabinet assembly being assemblable on site in the edifice from disassembled cabinet assembly components, the components including at least a selected plurality of panels, a top panel, and a rail, the rail being fixedly couplable to the wall, the respective panels being shiftably suspendable from the rail during assembly and the panels being substantially supported by the underlying floor by individually adjustable supports after assembly, and the top panel being compressively held between a portion of the rail and the panels to rigidize the cabinet.

12. The cabinet of claim 11, comprising a bracket fixedly couplable to a respective panel, the bracket being adapted for engaging the rail in a depending disposition.

13. The cabinet of claim 12, the bracket having a hook member, the hook member for engaging a mating hook member of the rail.

14. The cabinet of claim 13, wherein a top panel is removably, compressively captured by the bracket, the top panel thereby acting to compressively maintain the respective panels in suspended engagement with the rail.

15. The cabinet of claim 11, the rail providing a single datum from which all of the plurality of panels are suspended for minimizing the number of steps necessary to level the cabinet assembly.

16. The cabinet of claim 11, wherein the cabinet assembly employs the wall as a back portion of the cabinet assembly, thereby eliminating the need for a dedicated cabinet assembly back panel.

17. The cabinet of claim 11, including a corner bracket, the corner bracket having a hook and three orthogonally disposed members, the hook member for engaging a mating hook member of the rail, and the respective orthogonally disposed members for coupling to a respective panel, top panel, and the wall.

18. The cabinet of claim 11, including suspending a first panel and a second panel from the rail in a selected spaced apart disposition, the panels including adjustable cleats for affixing the first panel and the second panel to the underlying floor.

19. The cabinet of claim 18, including suspending a selected number of panels from the rail in selected spaced apart dispositions between the first panel and the second panel and each of the selected number of panels including a plurality of adjustable feet for at least in part supporting the selected number of panels on the underlying floor.

20. The cabinet of claim 11, including a single panel being provided between adjacent columns of the cabinet assembly, each of the single panels being adapted for supporting shelves on opposing sides of the respective single panels.

21. A method of assembling a cabinet on site in an edifice adjacent an edifice wall and above an edifice underlying floor, comprising:
shipping a plurality of cabinet members to the site in a generally flat configuration, the cabinet members including at least a selected plurality of panels, shelves, and doors and including a rail, the rail being formed of at least one rail member;
fixedly coupling the rail to the edifice wall;
suspending a first end panel and a second end panel from the rail in a selected spaced apart disposition;
affixing the first end panel and the second end panel to the underlying floor by means of adjustable cleats;
suspending a selected number of panels from the rail in selected spaced apart dispositions between the first end panel and the second end panel; and
at least partially supporting the selected number of panels on the underlying floor by means of adjustable feet.

22. The method of claim 21, further comprising the step of fixedly coupling a bracket to a respective panel, the bracket being adapted for engaging the rail in a depending disposition.

23. The method of claim 22, further comprising the bracket having a hook member, and engaging the hook member with a mating hook member of the rail.

24. The method of claim 23, further comprising compressively engaging a top panel with the bracket, the top panel thereby acting to maintain the respective panels in suspended engagement with the rail.

25. The method of claim 24, further comprising leveling all of the plurality of panels suspended by the rail through by leveling the rail itself.

26. The method of claim 21, further comprising employing the wall as a back portion of the cabinet assembly, thereby eliminating the need for a back panel.

27. The method of claim 21, further comprising engaging the hook member of the corner bracket with the a mating hook member of the rail corner bracket, and engaging the three orthogonally disposed members with the respective orthogonally disposed members of the respective panel, the top panel, and the wall.

28. The cabinet of claim 1, further comprising suspending the first panel and the second panel from the rail in a selected spaced apart disposition, and affixing the adjustable cleats of the first panel and the second panel to the underlying floor.

29. The cabinet of claim 28, further comprising suspending a selected number of panels from the rail in selected spaced apart dispositions between the first panel and the second panel and adjusting the plurality of adjustable feet of each of the selected number of panels to at least in part support the selected number of panels on the underlying floor.

30. The cabinet of claim 20, further comprising adapting a single panel for supporting one or more shelves on opposing sides of the respective single panel.

31. The cabinet of claim 1, further comprising a barbed connector for connecting a first panel to a second panel.

32. The cabinet of claim 31, the barbed connector having a barbed member, the barbed member being couplable to a slot defined in a panel.

33. The cabinet of claim 32, the barbed member of the barbed connector being disposable in the slot by means of a press fit.

34. The cabinet of claim 1, further comprising at least one door extrusion, removably couplable to a face of a respective one of each of the plurality of panels, the door extrusion acting to prevent removal of at least one shelf when the door extrusion is coupled to a panel.

35. The cabinet of claim 34, the at least one door extrusion hingedly supporting at least one door.
